(19) United States
(12) Patent Application Publication
(10) Pub. No.: US 2026/0178278 A1
(43) Pub. Date: Jun. 25, 2026

(54) PSEUDORANDOM NUMBER GENERATION IN HARDWARE

(71) Applicant: ADVANCED MICRO DEVICES, INC., Santa Clara, CA (US)

(72) Inventors: Shubra Marwaha, Santa Clara, CA (US); Bin He, Orlando, FL (US); Subramaniam Maiyuran, Folsom, CA (US); Brian Emberling, Palo Alto, CA (US); Justin David Smith, Mission Viejo, CA (US)

(21) Appl. No.: 18/999,242

(22) Filed: Dec. 23, 2024

(51) Int. Cl. G06F 7/58

(52) U.S. Cl. CPC G06F 7/582

(57) ABSTRACT

Systems and techniques for providing pseudorandom number generation include generating a pseudorandom number based on a bitwise exclusive-OR, or XOR, function that compares a shifted version of an input seed with one of a plurality of values, where one of the values is selected based on whether a first bit of the input seed is set or unset. An initial seed value is stored in hardware or generated based on an unknown value stored in memory, and successive outputs of the pseudorandom number generation are used as seeds in subsequent pseudorandom number generation operations.

### BACKGROUND

Many advanced applications, such as machine learning applications that utilize reduced precision data, use random numbers in the execution of various tasks. Random number generation is inherently challenging in computing due to the need for unpredictability and uniform distribution, which can be difficult to achieve with deterministic algorithms (i.e., algorithms that produce the same output for given inputs). Most computers use algorithms that generate “pseudorandom” numbers based on initial seed values, which are referred to as pseudorandom because the output can be predicted if the seed is known. However, even generation of pseudorandom numbers can be difficult, as there are a multitude of different methods for doing so and programmers often have to spend time determining how to best implement pseudorandom number generation for various functions, such as stochastic rounding or game design.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system providing pseudorandom number generation in a multi-chiplet processor according to some implementations.

FIG. 2 is a block diagram of a method of pseudorandom number generation in a multi-chiplet processor according to some implementations.

FIG. 3 is a list of an example initial seed and pseudorandom numbers generated using the example initial seed.

FIG. 4 is a flow diagram of a method of generating pseudorandom numbers in multi-chiplet processors according to some implementations.

### DETAILED DESCRIPTION

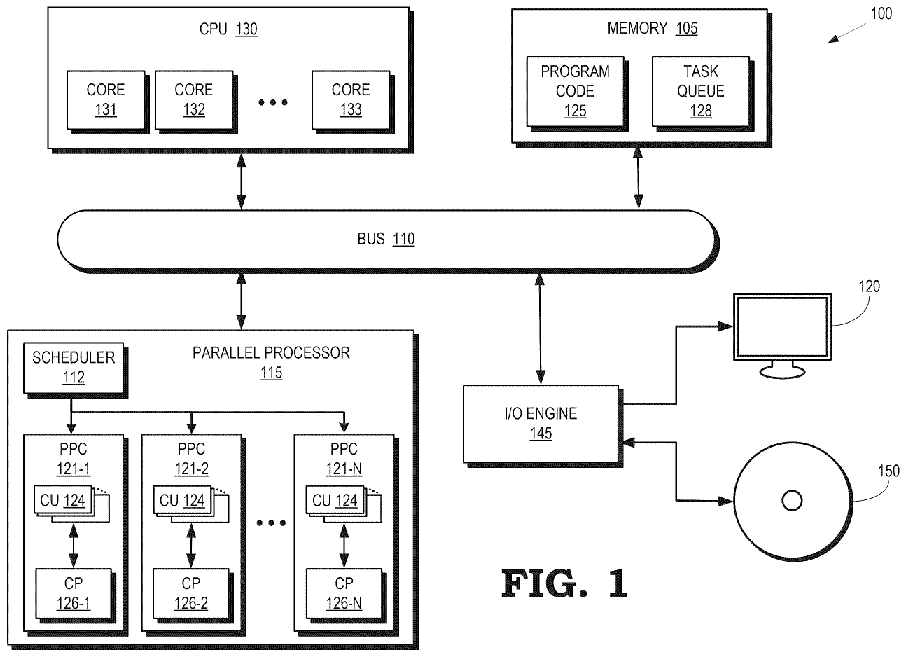

FIGS. 1-4 illustrate systems and techniques for pseudorandom number generation. In some implementations, the pseudorandom number generation methods disclosed herein are implemented in hardware and used by internal functions, such as functions that implement arithmetic, stochastic rounding, and conversion from higher precision representations of numbers to lower precision representations. In some implementations, programmers are able to utilize the hardware pseudorandom number generation methods disclosed herein to generate pseudorandom values, reducing the burden of producing and executing software that requires such values.

In some implementations, a pseudorandom number is generated based on a bitwise exclusive-OR, or XOR, function that compares a shifted version of an input seed with one of a plurality of values (e.g., 0x00 and 0xC5), where one of the values is selected based on whether a first bit of the input seed is set (i.e., has a value of 1) or unset (i.e., has a value of 0). A bitwise XOR function outputs true (or “1”) for each bit position only when the inputs have differing values in that bit position. For example, 0010 XOR 0000 produces a value of 0010, while 0010 XOR 1111 produces a value of 1101. Selecting one of a plurality of values to XOR with a shifted version of an input seed introduces additional variability into the pseudorandom number generation without requiring substantial additional computational requirements or power usage. In some implementations, an initial seed value is stored in hardware or generated based on an unknown value stored in memory. In some implementations, successive outputs of the pseudorandom number generation are used as seeds in subsequent pseudorandom number generation operations. However, in some implementations, if the pseudorandom number generation produces a value of zero, a new seed is selected, e.g., from a value stored in hardware or generated based on an unknown value stored in memory. In some implementations, pseudorandom number generation and instructions that utilize or consume the generated pseudorandom numbers run in parallel.

FIG. 1 is a block diagram of a processing system 100 providing pseudorandom number generation in a multi-chiplet processor according to some implementations. The processing system 100 includes or has access to a memory 105 or other storage component that is implemented using a non-transitory computer readable medium such as a dynamic random-access memory (DRAM). However, in some cases, the memory 105 is implemented using other types of memory including static random-access memory (SRAM), nonvolatile RAM, and the like. The memory 105 is referred to as an external memory as it is implemented external to the processing units implemented in the processing system 100. The processing system 100 also includes a bus 110 to support communication between entities implemented in the processing system 100, such as the memory 105. Some implementations of the processing system 100 include other buses, bridges, switches, routers, and the like, which are not shown in FIG. 1 in the interest of clarity.

The techniques described herein are, in different implementations, employed at any of a variety of parallel processors (e.g., vector processors, GPUs, general-purpose GPUs (GPGPUs), non-scalar processors, highly parallel processors, artificial intelligence (AI) processors, inference engines, machine learning processors, other multithreaded processing units, and the like). FIG. 1 illustrates an example of a multi-chiplet processor, which is implemented in the illustrated example as parallel processor 115, in accordance with some implementations. In some implementations, the parallel processor 115 renders images for presentation on a display 120. For example, the parallel processor 115 renders objects to produce values of pixels that are provided to the display 120, which uses the pixel values to display an image that represents the rendered objects. However, the parallel processor 115 is also capable of executing software not directly involved in any graphics processing pipeline, such as machine learning applications and other advanced computing applications.

In order to provide the parallel processor 115 with the flexibility to execute tasks related to a graphics processing pipeline, machine learning, or other advanced computing applications in an efficient manner, the parallel processor 115 includes a plurality of parallel processing chiplets (PPCs), such as PPCs 121-1, 121-2, and 121-N, which are configured to process tasks and offer one or more of GPU functionality and optimized processing for advanced applications that utilize, e.g., reduced precision data common in machine learning. By providing the parallel processor 115 with a plurality of PPCs 121, the parallel processor 115 is able to perform a number of tasks simultaneously while latency and data transfer energy between the PPCs 121 is minimized. The PPCs 121 are typically implemented using shared hardware resources of the parallel processor 115, such as compute units 124. In some implementations, the PPCs 121 are used to implement shaders, such as geometry shaders, pixel shaders, and the like. Generally, the PPCs 121 are a logical grouping of processing hardware, which in some implementations includes, e.g., one or more processing chiplets, cores, and/or caches. The PPCs 121 typically include or access a number of compute units 124 in the parallel processor 115, and each of the compute units 124 typically includes a number of single-instruction-multiple-data (SIMD) units. The number of PPCs 121 implemented in the parallel processor 115 is a matter of design choice and some implementations of the parallel processor 115 include more or fewer PPCs than are shown in FIG. 1.

In some implementations, the processing system 100 also includes a CPU 130 that is connected to the bus 110 through which it communicates with the parallel processor 115 and the memory 105. The CPU 130 implements a plurality of processor cores 131, 132, 133 (collectively referred to herein as “processor cores 131-133”) that execute instructions concurrently or in parallel. The number of processor cores 131-133 implemented in the CPU 130 is a matter of design choice and some implementations include more or fewer processor cores than are illustrated in FIG. 1. The processor cores 131-133 execute instructions such as program code 125 stored in the memory 105 and the CPU 130 stores information in the memory 105 such as the results of the executed instructions. The CPU 130 is also able to initiate graphics or other processing by issuing draw calls or other tasks to the parallel processor 115.

In some implementations, as shown in the example of FIG. 1, the PPCs 121 each include a CP 126, such as CPs 126-1, 126-2, and 126-N, to manage and facilitate execution of incoming instructions or tasks. Tasks are stored in a task queue 128 in the memory 105, which also stores dependency information related to the tasks. In some implementations, the task queue 128 is duplicated or instead stored in the parallel processor 115 and/or CPU 130. Generally, the task queue 128 is stored in a location accessible by the CPU 130 and the parallel processor 115 so that the status of the tasks and dependency information in the task queue 128 can be monitored and new tasks and dependency information can be added as needed by, e.g., the CPU 130 or the parallel processor 115. In some implementations, the task queue 128 is implemented as a circular buffer with associated read and write pointers, but in other implementations the task queue 128 takes other forms such as an ordered list or cache.

As shown in FIG. 1, the parallel processor 115 further includes a scheduler 112, which is implemented as any cooperating collection of hardware, software, or a combination thereof that performs functions and computations associated with assigning threads, workgroups, waves, or other tasks, such as compute shader threads, to one or more of the PPCs 121. In some implementations, one or more of the PPCs 121 are able to be selectively addressed or controlled independently from one another or addressed or controlled in groups of two or more such that the parallel processor 115, the scheduler 112, and/or a user is able to control which PPCs 121 perform specific tasks or to distribute tasks across a number of PPCs 121. In some implementations, the parallel processor 115 is used for general purpose computing. The parallel processor 115 executes instructions such as program code 125 stored in the memory 105 based on dependency information stored in the task queue 128, and the parallel processor 115 stores information in the memory 105 such as the results of the executed instructions, new dependency information for tasks, and indications that dependencies have been satisfied, e.g., when tasks associated with dependency information have finished executing.

In some implementations, the scheduler 112 and the CPs 126 work together or in parallel to process tasks and dependency information from the task queue 128. For example, in some implementations, the scheduler 112 assigns tasks to the compute units 124, and the compute units 124 interface with the task queue 128 to determine when tasks can be executed out of order based on dependency information specified in the task queue 128. In some implementations, the scheduler 112 interfaces with the task queue 128 to determine which tasks to assign to the compute units 124 based on the dependency information. Accordingly, in some implementations, the scheduler 112 and compute units 124 work together to ensure maximum parallelization and optimized throughput of task execution in the parallel processor 115.

In some implementations, at least one of the PPCs 121, compute units 124, and/or CPs 126 includes hardware configured to generate a pseudorandom number based on a bitwise exclusive-OR, or XOR, function. In particular, a shifted version of an input seed is compared with one of a plurality of values (e.g., 0x00 and 0xC5), where one of the values is selected based on whether a first bit of the input seed is set (i.e., has a value of 1) or unset (i.e., has a value of 0). By selecting one of a plurality of values to XOR with a shifted version of an input seed, pseudorandom numbers can be generated quickly and efficiently.

An input/output (I/O) engine 145 handles input or output operations associated with the display 120, as well as other elements of the processing system 100 such as keyboards, mice, printers, external disks, and the like. The I/O engine 145 is coupled to the bus 110 so that the I/O engine 145 communicates with the memory 105, the parallel processor 115, or the CPU 130. In the illustrated implementation, the I/O engine 145 reads information stored on an external storage component 150, which is implemented using a non-transitory computer readable medium such as a compact disk (CD), a digital video disc (DVD), and the like. The I/O engine 145 is also able to write information to the external storage component 150, such as the results of processing by the parallel processor 115 or the CPU 130.

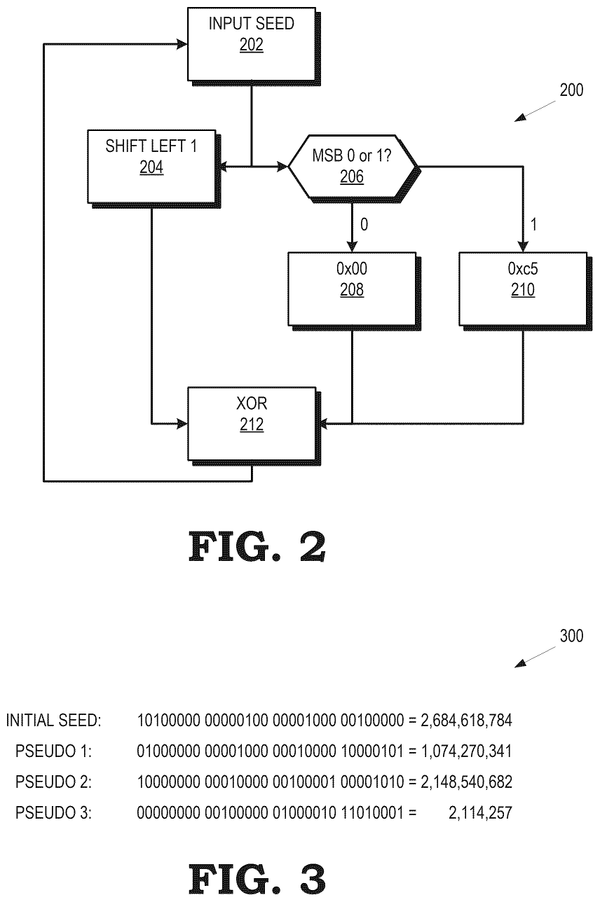

FIG. 2 is a block diagram of a method 200 of pseudorandom number generation according to some implementations. In some implementations, at least one of the PPCs 121, compute units 124, and/or CPs 126 of the system 100 of FIG. 1 includes hardware configured to generate a pseudorandom number based on an exclusive-OR function that compares a shifted version of an input seed with one of two predetermined values. In some implementations, the compute units 124 perform pseudorandom number generation tasks. As shown in FIG. 2, the method 200 begins at block 202 with an initial input seed. In some implementations, a predetermined initial input seed is stored in a hardware register or a memory, such as the memory 105 of FIG. 1. However, in some implementations, the initial input seed is generated based on an unknown value stored in memory, such as an address in memory expected to have a high degree of variability (e.g., a memory storing a temporary cache, a timer, or a clock).

At block 204, a compute unit 124 shifts the initial input seed to the left by one bit, which, in binary, is equivalent to multiplying the input seed by two. For example, in some implementations, shifting the binary value 0010 1000 left produces a value of 0101 0000. At block 206, the compute unit 124 identifies the most significant bit of the initial input seed as having a value of 0 or 1. If the value is 0, the method 200 proceeds to block 208 and the compute unit 124 selects a hexadecimal value of 0x00 (binary 0000 0000); however, if the most significant bit of the initial input seed has a value of 1, the method proceeds to block 210 and the compute unit 124 selects a hexadecimal value of 0xc5 (binary 1100 0101). Notably, in some implementations, the compute unit 124 shifts the initial input seed to the left or to the right by any number of appropriate bits at block 204. In some implementations, values other than 0x00 and 0xc5 are used. Further, in some implementations, rather than selecting one of a plurality of values based on a first or most significant bit of the input seed, one of the values is selected based on one of the other bits or two or more of the bits of the input seed. In some implementations, the two values are not predetermined and instead are generated based on an unknown value stored in memory. In some implementations, one of a plurality of predetermined values or values generated based on unknown values stored in memory is selected. To determine which of these values will be selected, in some implementations, the most significant two or more bits or a different set of bits of the input seed are used as an index to identify a value to be selected. For example, in some implementations, one value is associated with a binary value of 010, a second value is associated with a binary value of 011, and a third value is associated with a binary value of 000 such that when a set of bits in the input seed have values of “0 ,” “0 ,” and “0 ,” the third value will be selected.

At block 212, compute unit 124 compares the shifted version of the initial input seed to the value selected at block 208 or block 210 to produce a pseudorandom number using an exclusive-OR or XOR function. However, in some implementations, the compute unit 124 uses a Boolean function other than XOR at block 212, such as an XNOR or an OR function. Subsequently, in some implementations and as shown in FIG. 2, the generated pseudorandom number is used as an input seed at block 202 for generating a subsequent pseudorandom number. However, in some implementations, if the pseudorandom number generation produces a value of zero, a new seed is selected, e.g., from a predetermined value stored in hardware or generated based on an unknown value stored in memory. In some implementations, pseudorandom number generation and instructions that utilize or consume the generated pseudorandom numbers run in parallel.

FIG. 3 is a list 300 of an example initial seed and pseudorandom numbers generated using the example initial seed. For example, if an initial seed is a 32-bit value that is either predetermined or generated based on a value stored in memory, the initial seed may have a value as indicated in FIG. 3, i.e.:
10100000 00000100 00001000 00100000.

When this initial seed is processed by the method 200, at block 204, the seed is shifted left once, resulting in the value:
01000000 00001000 00010000 01000000.

At block 206, the most significant bit of the input seed is determined to have a value of 1, and so the value 0xc5 (binary 1100 0101) is selected. At block 212, the last eight bits of the left-shifted version of the input seed generated at block 204 are compared with the value 0xc5 to produce a pseudorandom number, i.e.:
01000000 00001000 00010000 10000101.

Accordingly, using the initial input seed shown in FIG. 3, which, if treated as an unsigned value, has a decimal equivalent value of 2,684,618,784, the method 200 produces the first pseudorandom value shown in FIG. 3, which has a decimal equivalent value of 1,074,270,341. As shown in FIG. 3, when the first pseudorandom number is used as the input seed at block 202 to produce a second pseudorandom number, the result has a decimal equivalent value of 2,148,540,682. When a third pseudorandom number is generated using the second pseudorandom number shown in FIG. 3 as the input seed, the method 200 produces a decimal equivalent value of 2,114,257. Accordingly, although the method 200 is efficient and easy to implement, it generates highly variable pseudorandom numbers that can be used for functions that can use pseudorandom numbers to implement, e.g., arithmetic, stochastic rounding, and conversion from higher precision representations of numbers to lower precision representations. In some implementations, the method 200 generates pseudorandom numbers for internal system routines, such as conversions, and/or for programmers to utilize as needed.

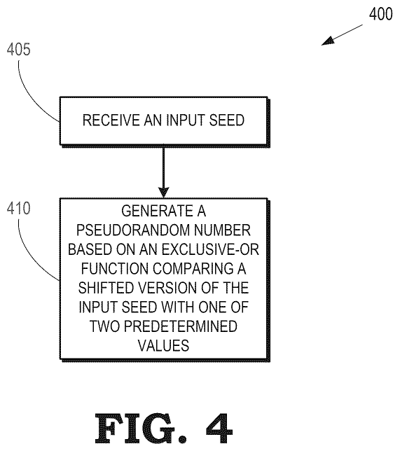

FIG. 4 is a flow diagram of a method 400 of generating pseudorandom numbers according to some embodiments. In some implementations, the pseudorandom numbers are generated by hardware in a multi-chiplet processor, such as the parallel processor 115 of FIG. 1 including a plurality of PPCs 121, according to some implementations. In some implementations, the method 400 is executed by at least one of the PPCs 121, compute units 124, and/or CPs 126 of the system 100 of FIG. 1. At block 405 of the method 400, the compute unit 124 receives an input seed. At block 410, the compute unit 124 generates a pseudorandom number based on an exclusive-OR function comparing a shifted version of the input seed with one of a plurality of predetermined values. In some implementations, as described further hereinabove, the method 400 includes selecting one of the two predetermined values for the comparing based on a first bit of the input seed. In some implementations, the method 400 includes storing a predetermined initial input seed in hardware. In some implementations, the method 400 includes generating the input seed based on an unknown value stored in memory. In some implementations, the method 400 includes using the generated pseudorandom number as an input seed for generating a subsequent pseudorandom number. In some implementations, the two predetermined values include a first predetermined value of 0xc5 or 11000101 and a second predetermined value of 0x00 or 00000000. In some implementations, the method 400 includes generating the shifted version of the input seed by left-shifting the input seed.

In some implementations, the apparatuses and techniques described above are implemented in a system including one or more integrated circuit (IC) devices (also referred to as integrated circuit packages or microchips), such as the parallel processor 115, the PPCs 121, the compute units 124, the CPs 126, and the methods 200 and 400 described above. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” “engines,” “workgroups,” “launchers,” “interfaces,” “chiplets,” etc.) are described or claimed as “configured” to perform one or more tasks or operations. This formulation of “[entity] configured to [perform one or more tasks]” is used herein to refer to structure (e.g., a physical element, such as electronic circuitry, or an algorithm in software executed by such a physical element). More specifically, this formulation is used to indicate that this physical structure is arranged to perform the one or more tasks during operation. A structure can be said to be “configured to” perform some task even if the structure is not currently being operated. Thus, an entity described or recited as “configured to” perform some task refers to a physical element, such as a device, circuitry, memory storing program instructions executable to implement the task, or an algorithm executed using such a physical element. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. An apparatus comprising:
a parallel processor, wherein:
a compute unit of the parallel processor is configured to generate a pseudorandom number based on an exclusive-OR function that compares a shifted version of an input seed with one of a plurality of predetermined values.

2. The apparatus of claim 1, wherein the compute unit is configured to select one of the plurality of predetermined values for the comparison based on at least a first bit of the input seed.

3. The apparatus of claim 1, wherein the input seed is a predetermined initial input seed stored in hardware.

4. The apparatus of claim 1, wherein the compute unit is configured to generate the input seed based on an unknown value stored in memory.

5. The apparatus of claim 1, wherein the compute unit is configured to selectively use the generated pseudorandom number as an input seed for generating a subsequent pseudorandom number.

6. The apparatus of claim 1, wherein the plurality of predetermined values includes a first predetermined value of 0xc5 or 11000101.

7. The apparatus of claim 6, wherein the plurality of predetermined values includes a second predetermined value of 0x00 or 00000000.

8. The apparatus of claim 1, wherein the shifted version of the input seed is a left-shifted version of the input seed.

9. The apparatus of claim 8, wherein the left-shifted version of the input seed is shifted left at least once.

10. A method, comprising:
receiving an input seed; and
generating, at a compute unit of a parallel processing chiplet, a pseudorandom number based on an exclusive-OR function comparing a shifted version of the input seed with one of a plurality of predetermined values.

11. The method of claim 10, further comprising selecting one of the plurality of predetermined values for the comparing based on a first bit of the input seed.

12. The method of claim 10, further comprising storing a predetermined initial input seed in hardware.

13. The method of claim 10, further comprising generating the input seed based on an unknown value stored in memory.

14. The method of claim 10, further comprising selectively using the generated pseudorandom number as an input seed for generating a subsequent pseudorandom number.

15. The method of claim 10, wherein the plurality of predetermined values include a first predetermined value of 0xc5 or 11000101.

16. The method of claim 10, wherein the plurality of predetermined values include a second predetermined value of 0x00 or 00000000.

17. The method of claim 10, further comprising generating the shifted version of the input seed by left-shifting the input seed.

18. A system comprising:
a memory configured to store an input seed; and
a processor comprising a compute unit configured to
generate a pseudorandom number based on an exclusive-OR function that compares a shifted version of an input seed with one of a plurality of predetermined values.

19. The system of claim 18, wherein the processor selects one of the plurality of predetermined values for the comparison based on a first bit of the input seed.

20. The system of claim 18, wherein the processor uses the generated pseudorandom number as an input seed for generating a subsequent pseudorandom number.
